(19) United States
(12) Patent Application Publication
(10) Pub. No.: US 2021/0097305 A1
(43) Pub. Date: Apr. 1, 2021

(54) PERIPHERY MONITORING DEVICE AND PERIPHERY MONITORING PROGRAM

(71) Applicant: AISIN SEIKI KABUSHIKI KAISHA, Kariya-shi (JP)

(72) Inventors: Yoshihito Kokubo, Kariya-shi (JP); Yoshihisa Suetsugu, Kariya-shi (JP)

(73) Assignee: AISIN SEIKI KABUSHIKI KAISHA, Kariya-shi (JP)

(21) Appl. No.: 17/016,560

(22) Filed: Sep. 10, 2020

(30) Foreign Application Priority Data
Sep. 30, 2019 (JP) 2019-180692

(51) Int. Cl. G06K 9/00; G06T 7/70; B60R 1/00

(52) U.S. Cl. CPC G06K 9/00791; G06T 7/70; G06T 2207/20084; G06T 2207/30252; B60R 1/002

(57) ABSTRACT

A periphery monitoring device includes: an image obtaining unit configured to obtain a captured image captured by an image capturing unit provided in a vehicle so as to image an area including a road surface on periphery of the vehicle; and a restoration control unit configured to control, when the captured image includes a spotted area caused by a spot on an optical system of the image capturing unit, whether to execute restoration processing of outputting a restored image restored from the captured image so as to simulatively reproduce a state where the optical system of the image capturing unit does not have the spot by removing the spotted area, according to a positional relationship between a road surface area where the road surface is captured and the spotted area in the captured image.

### CROSS REFERENCE TO RELATED APPLICATIONS

This application is based on and claims priority under 35 U.S.C. § 119 to Japanese Patent Application 2019-180692, filed on Sep. 30, 2019, the entire content of which is incorporated herein by reference.

### TECHNICAL FIELD

This disclosure relates to a periphery monitoring device and a periphery monitoring program.

### BACKGROUND DISCUSSION

In the related art, there is a technique for causing a driver or the like to monitor a situation on the periphery of a vehicle by outputting a captured image captured by an image capturing unit mounted on the vehicle to a display device. In such a technique, when the captured image includes a spotted area caused by a spot such as water droplets, dust, or mud attached to an optical system (for example, a lens) of the image capturing unit, even if the captured image is output as it is, the situation on the periphery of the vehicle may not be appropriately monitored. Therefore, a technique for generating a restored image restored from the captured image so as to simulatively reproduce a state where the optical system of the image capturing unit does not have the spot by removing the spotted area is being studied.

Examples of the related art include WO 2017/078072 (Reference 1) and JP 2018-197666A (Reference 2).

However, in the above technique, a situation may occur in which even though an object supposed to be monitored actually exists on a road surface, an area where the object is supposed to be captured is removed together with the spotted area from the restored image because the area where the object is supposed to be captured and the spotted area overlap according to a positional relationship between a road surface area where the road surface is captured and the spotted area. Therefore, it is not appropriate to always use the restored image in any situation to monitor the situation on the periphery of the vehicle.

A need thus exists for a periphery monitoring device and a periphery monitoring program which is not susceptible to the drawback mentioned above.

### SUMMARY

A periphery monitoring device according to an aspect of this disclosure includes: an image obtaining unit configured to obtain a captured image captured by an image capturing unit provided in a vehicle so as to image an area including a road surface on periphery of the vehicle; and a restoration control unit configured to control, when the captured image includes a spotted area caused by a spot on an optical system of the image capturing unit, whether to execute restoration processing of outputting a restored image restored from the captured image so as to simulatively reproduce a state where the optical system of the image capturing unit does not have the spot by removing the spotted area, according to a positional relationship between a road surface area where the road surface is captured and the spotted area in the captured image.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is an exemplary and schematic diagram showing a configuration inside a passenger compartment of a vehicle according to an embodiment;

FIG. 2 is an exemplary and schematic diagram showing an appearance of the vehicle according to the embodiment when viewed from above;

FIG. 3 is an exemplary and schematic block diagram showing a system configuration of the vehicle according to the embodiment;

FIG. 4 is an exemplary and schematic diagram showing an example of a captured image that can be obtained by a vehicle-mounted camera according to the embodiment;

FIG. 5 is an exemplary and schematic diagram showing an example of a captured image that can be obtained by the vehicle-mounted camera according to the embodiment which is different from the captured image in FIG. 4;

FIG. 6 is an exemplary and schematic block diagram showing a configuration of a periphery monitoring device according to the embodiment;

FIG. 7 is an exemplary and schematic diagram for illustrating restoration of a captured image executed in the embodiment;

FIG. 8 is an exemplary and schematic diagram for illustrating calculation of an evaluation value executed in the embodiment; and

FIG. 9 is an exemplary and schematic flow chart showing a series of processing executed by the periphery monitoring device according to the embodiment.

### DETAILED DESCRIPTION

Hereinafter, embodiments and modifications disclosed here will be described with reference to the drawings. Configurations of the embodiments and the modifications described below and actions and effects provided by the configurations are merely examples, and are not limited to the following description.

### Embodiment

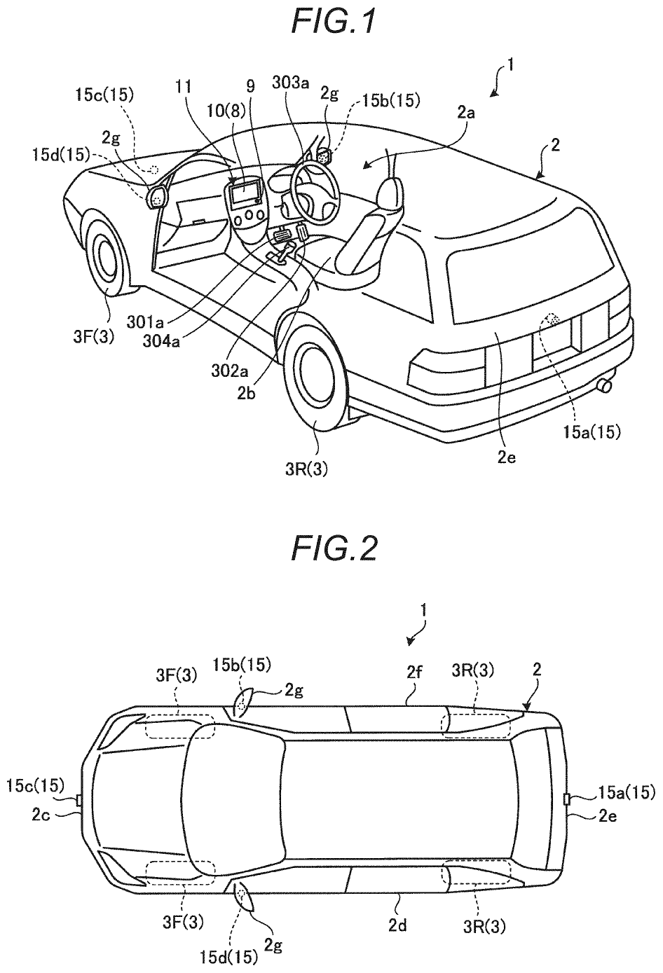

First, a schematic configuration of a vehicle 1 according to an embodiment will be described with reference to FIGS. 1 and 2. FIG. 1 is an exemplary and schematic diagram showing a configuration inside a passenger compartment 2a of the vehicle 1 according to the embodiment, and FIG. 2 is an exemplary and schematic diagram showing an appearance of the vehicle 1 according to the embodiment when viewed from above.

As shown in FIG. 1, the vehicle 1 according to the embodiment includes the passenger compartment 2a in which passengers including a driver as a user board. In the passenger compartment 2a, a braking unit (braking operation unit) 301a, an acceleration unit (acceleration operation unit) 302a, a steering unit 303a, a transmission unit (transmission operation unit) 304a, and the like are provided in a state of being operable by the user from a seat 2b.

The braking unit 301a is, for example, a brake pedal provided under a foot of the driver, and the acceleration unit 302a is, for example, an accelerator pedal provided under the foot of the driver. Further, the steering unit 303a is, for example, a steering wheel that projects from a dashboard (instrument panel), and the transmission unit 304a is, for example, a shift lever that projects from a center console. The steering unit 303a may be a handle.

The passenger compartment 2a is provided with a monitor device 11 including a display unit 8 capable of outputting various images and an audio output unit 9 capable of outputting various sounds. The monitor device 11 is provided, for example, in a center portion in a width direction (left-right direction) of the dashboard in the passenger compartment 2a. The display unit 8 is formed of, for example, a liquid crystal display (LCD) or an organic electroluminescence display (OELD).

Here, an operation input unit 10 is provided on a display screen as an area where an image is displayed on the display unit 8. The operation input unit 10 is configured as, for example, a touch panel capable of detecting coordinates of a position where an indicator such as a finger or a stylus approaches (including contact). Accordingly, the user (driver) can visually recognize the image displayed on the display screen of the display unit 8, and various operation input can be executed by performing a touch (tap) operation or the like on the operation input unit 10 using the indicator.

In the embodiment, the operation input unit 10 may be various physical interfaces such as a switch, a dial, a joystick, and a push button. Further, in the embodiment, another audio output device may be provided at a position different from the position of the monitor device 11 in the passenger compartment 2a. In this case, various kinds of sound information can be output from both the audio output unit 9 and another audio output device. Further, in the embodiment, the monitor device 11 may be configured to be able to display information related to various systems such as a navigation system and an audio system.

Further, as shown in FIGS. 1 and 2, the vehicle 1 according to the embodiment is configured as a four-wheeled vehicle including two left and right front wheels 3F and two left and right rear wheels 3R. Hereinafter, for simplification, the front wheels 3F and the rear wheels 3R may be collectively referred to as a wheel 3. In the embodiment, side slip angles of one or all of the four wheels 3 change (steer) according to an operation of the steering unit 303a.

Further, the vehicle 1 is equipped with a plurality of (four in an example shown in FIGS. 1 and 2) vehicle-mounted cameras 15a to 15d. The vehicle-mounted cameras 15a to 15d are examples of “image capturing unit”.

The vehicle-mounted cameras 15a to 15d are provided on the vehicle 1 so as to image an area including a road surface on periphery of the vehicle 1. More specifically, the vehicle-mounted camera 15a is provided at a rear end portion 2e (for example, below a rear door) of a vehicle body 2, and images an area including a road surface behind the vehicle 1. The vehicle-mounted camera 15b is provided on a door mirror 2g at a right end portion 2f of the vehicle body 2, and images an area including a road surface on a right side of the vehicle 1. Further, the vehicle-mounted camera 15c is provided at a front end portion 2c (for example, a front bumper) of the vehicle body 2, and images an area including a road surface in front of the vehicle 1. Further, the vehicle-mounted camera 15d is provided on the door mirror 2g at a left end portion 2d of the vehicle body 2, and images an area including a road surface on a left side of the vehicle 1. Hereinafter, for simplification, the vehicle-mounted cameras 15a to 15d may be collectively referred to as a vehicle-mounted camera 15.

The vehicle-mounted camera 15 is, for example, a so-called digital camera including an image capturing element such as a charge coupled device (CCD) or an image sensor (complementary metal oxide semiconductor (CMOS) CIS). The vehicle-mounted camera 15 images the periphery of the vehicle 1 at a predetermined frame rate, and outputs image data of a captured image obtained by the imaging. The image data obtained by the vehicle-mounted camera 15 can form a moving image as a frame image.

In the embodiment, as a configuration for sensing a situation on the periphery of the vehicle 1, in addition to the vehicle-mounted camera 15 described above, a distance measuring sensor that detects (calculates and specifies) a distance to a three-dimensional object existing on the periphery of the vehicle 1 may be provided. As such a distance measuring sensor, for example, a sonar that transmits sound waves and receives sound waves reflected from an object existing on the periphery of the vehicle 1 or a laser radar that transmits radio waves such as light and receives radio waves reflected from an object existing on the periphery of the vehicle 1 is used.

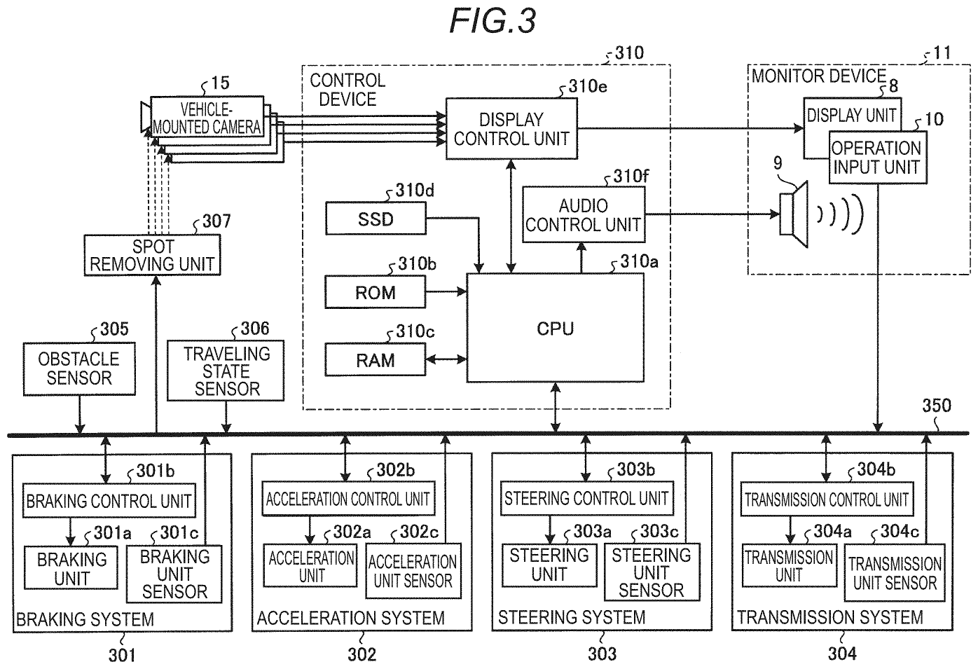

Next, a system configuration provided for implementing various control in the vehicle 1 according to the embodiment will be described with reference to FIG. 3. The system configuration shown in FIG. 3 is merely an example, and can be set (changed) in various ways.

FIG. 3 is an exemplary and schematic block diagram showing the system configuration of the vehicle 1 according to the embodiment.

As shown in FIG. 3, the vehicle 1 according to the embodiment includes a braking system 301, an acceleration system 302, a steering system 303, a transmission system 304, an obstacle sensor 305, a traveling state sensor 306, a spot removing unit 307, the vehicle-mounted camera 15, the monitor device 11, a control device 310, and a vehicle-mounted network 350.

The braking system 301 controls deceleration of the vehicle 1. The braking system 301 includes the braking unit 301a, a braking control unit 301b, and a braking unit sensor 301c.

The braking unit 301a is a device for decelerating the vehicle 1 such as the brake pedal described above.

The braking control unit 301b is configured, for example, as a microcomputer including a hardware processor such as a central processing unit (CPU). The braking control unit 301b controls a degree of the deceleration of the vehicle 1 by driving an actuator (not shown) based on an instruction received via the vehicle-mounted network 350 and operating the braking unit 301a, for example.

The braking unit sensor 301c is a device for detecting a state of the braking unit 301a. For example, when the braking unit 301a is configured as a brake pedal, the braking unit sensor 301c detects a position of the brake pedal or a pressure acting on the brake pedal as the state of the braking unit 301a. The braking unit sensor 301c outputs the detected state of the braking unit 301a to the vehicle-mounted network 350.

The acceleration system 302 controls acceleration of the vehicle 1. The acceleration system 302 includes the acceleration unit 302a, an acceleration control unit 302b, and an acceleration unit sensor 302c.

The acceleration unit 302a is a device for accelerating the vehicle 1 such as the accelerator pedal described above.

The acceleration control unit 302b is configured, for example, as a microcomputer including a hardware processor such as a CPU. The acceleration control unit 302b controls a degree of the acceleration of the vehicle 1 by driving the actuator (not shown) based on an instruction received via the vehicle-mounted network 350 and operating the acceleration unit 302a, for example.

The acceleration unit sensor 302c is a device for detecting a state of the acceleration unit 302a. For example, when the acceleration unit 302a is configured as an accelerator pedal, the acceleration unit sensor 302c detects a position of the accelerator pedal or a pressure acting on the accelerator pedal. The acceleration unit sensor 302c outputs the detected state of the acceleration unit 302a to the vehicle-mounted network 350.

The steering system 303 controls a traveling direction of the vehicle 1. The steering system 303 includes the steering unit 303a, a steering control unit 303b, and a steering unit sensor 303c.

The steering unit 303a is a device for steering steered wheels of the vehicle 1, such as the steering wheel or the handle described above.

The steering control unit 303b is configured, for example, as a microcomputer including a hardware processor such as a CPU. The steering control unit 303b controls the traveling direction of the vehicle 1 by driving the actuator (not shown) based on an instruction received via the vehicle-mounted network 350 and operating the steering unit 303a, for example.

The steering unit sensor 303c is a device for detecting a state of the steering unit 303a. For example, when the steering unit 303a is configured as a steering wheel, the steering unit sensor 303c detects a position of the steering wheel or a rotation angle of the steering wheel. When the steering unit 303a is configured as a handle, the steering unit sensor 303c may detect a position of the handle or a pressure acting on the handle. The steering unit sensor 303c outputs the detected state of the steering unit 303a to the vehicle-mounted network 350.

The transmission system 304 controls a transmission ratio of the vehicle 1. The transmission system 304 includes the transmission unit 304a, a transmission control unit 304b, and a transmission unit sensor 304c.

The transmission unit 304a is a device for changing the transmission ratio of the vehicle 1, such as the shift lever described above.

The transmission control unit 304b is configured, for example, as a computer including a hardware processor such as a CPU. The transmission control unit 304b controls the transmission ratio of the vehicle 1 by driving the actuator (not shown) based on an instruction received via the vehicle-mounted network 350 and operating the transmission unit 304a, for example.

The transmission unit sensor 304c is a device for detecting a state of the transmission unit 304a. For example, when the transmission unit 304a is configured as a shift lever, the transmission unit sensor 304c detects a position of the shift lever or a pressure acting on the shift lever. The transmission unit sensor 304c outputs the detected state of the transmission unit 304a to the vehicle-mounted network 350.

The obstacle sensor 305 is a device for detecting information related to an obstacle that may exist on the periphery of the vehicle 1. The obstacle sensor 305 includes a distance measuring sensor such as the sonar and the laser radar described above. The obstacle sensor 305 outputs the detected information to the vehicle-mounted network 350.

The traveling state sensor 306 is a device for detecting a traveling state of the vehicle 1. The traveling state sensor 306 includes, for example, a wheel speed sensor that detects a wheel speed of the vehicle 1, an acceleration sensor that detects an acceleration in a front-rear direction or the left-right direction of the vehicle 1, and a gyro sensor that detects a turning speed (an angular speed) of the vehicle 1. The traveling state sensor 306 outputs the detected traveling state to the vehicle-mounted network 350.

The spot removing unit 307 is a device that operates to physically remove a spot on an optical system (for example, a lens) of the plurality of vehicle-mounted cameras 15 mounted on the vehicle 1. The spot removing unit 307 can physically remove a spot such as water drops, dust, or mud attached to the optical system of the vehicle-mounted camera 15 by, for example, blowing air, applying vibration, supplying cleaning liquid, and the like to the optical system of the vehicle-mounted camera 15 under control of the control device 310.

The control device 310 is a device that integrally controls various systems provided in the vehicle 1. Details will be described below, and the control device 310 according to the embodiment has a function of executing substitution control for substituting at least a part of an driving operation of a driver on the vehicle 1, and a function of executing restoration processing of outputting a restored image restored from a captured image so as to simulatively reproduce a state where the optical system of the vehicle-mounted camera 15 does not have the spot by removing a spotted area when the captured image obtained by the vehicle-mounted camera 15 during the execution of the substitution control includes the spotted area caused by the spot on the optical system of the vehicle-mounted camera 15.

More specifically, the control device 310 is configured as an electronic control unit (ECU) including a central processing unit (CPU) 310a, a read only memory (ROM) 310b, a random access memory (RAM) 310c, a solid state drive (SSD) 310d, a display control unit 310e, and an audio control unit 310f.

The CPU 310a is a hardware processor that integrally controls the control device 310. The CPU 310a reads various control programs (computer programs) stored in the ROM 310b and the like, and implements various functions according to instructions defined in the various control programs. The various control programs include a periphery monitoring program for implementing periphery monitoring processing accompanied by the restoration processing.

The ROM 310b is a non-volatile main storage device that stores parameters and the like necessary for executing the various control programs described above.

The RAM 310c is a volatile main storage device that provides a work area for the CPU 310a.

The SSD 310d is a rewritable non-volatile auxiliary storage device. In the control device 310 according to the embodiment, a hard disk drive (HDD) may be provided as the auxiliary storage device instead of the SSD 310d (or in addition to the SSD 310d).

The display control unit 310e mainly controls image processing on the captured image obtained from the vehicle-mounted camera 15, generation of the image data to be output to the display unit 8 of the monitor device 11, and the like among various processing that can be executed by the control device 310.

The audio control unit 310f mainly controls generation of audio data to be output to the audio output unit 9 of the monitor device 11 and the like among various processing that can be executed by the control device 310.

The vehicle-mounted network 350 communicably connects the braking system 301, the acceleration system 302, the steering system 303, the transmission system 304, the obstacle sensor 305, the traveling state sensor 306, the spot removing unit 307, the operation input unit 10 of the monitor device 11, and the control device 310.

By the way, in the related art, there is known a technique for causing the driver or the like to monitor the situation on the periphery of the vehicle 1 by outputting the captured image captured by the vehicle-mounted camera 15 to the display unit 8. In such a technique, when the captured image includes the spotted area caused by a spot such as water droplets, dust, or mud attached to the optical system of the vehicle-mounted camera 15, even though the captured image is output as it is, the situation on the periphery of the vehicle 1 may not be monitored appropriately. Therefore, a technique for generating the restored image restored from the captured image so as to simulatively reproduce the state where the optical system of the vehicle-mounted camera 15 does not have the spot by removing the spotted area is being studied.

However, in the above technique, a situation may occur in which even though an object supposed to be monitored actually exists on a road surface, an area where the object is supposed to be captured is removed together with the spotted area from the restored image because the area where the object is supposed to be captured and the spotted area overlap according to a positional relationship between a road surface area where the road surface is captured and the spotted area.

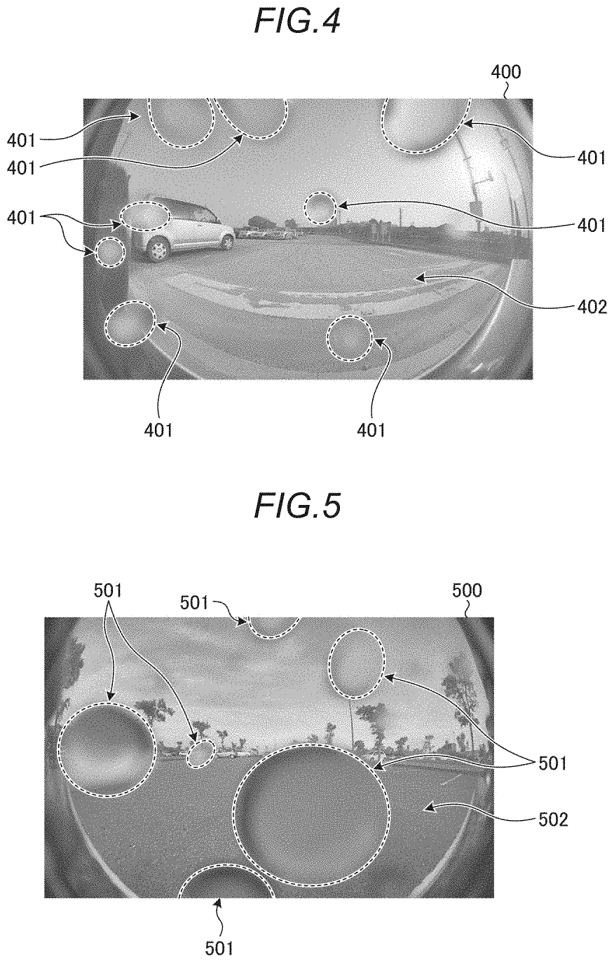

For example, FIG. 4 is an exemplary and schematic diagram showing an example of the captured image that can be obtained by the vehicle-mounted camera 15 according to the embodiment, and FIG. 5 is an exemplary and schematic diagram showing an example of a captured image that can be obtained by the vehicle-mounted camera 15 according to the embodiment which is different from the captured image in FIG. 4.

In an example shown in FIG. 4, an image 400 as the captured image includes spotted areas 401 caused by water droplets and a road surface area 402 where a road surface is captured. Further, in an example shown in FIG. 5, an image 500 as a captured image includes spotted areas 501 caused by water droplets and a road surface area 502 where a road surface is captured.

In the example shown in FIG. 4, overlap between the spotted areas 401 and the road surface area 402 is small. More specifically, in the example shown in FIG. 4, an area near the center of gravity (center) of the road surface area 402, which is an example of an area where the object supposed to be monitored is more likely to be reflected, and the spotted areas 401 do not overlap. Therefore, even if the image 400 shown in FIG. 4 is restored, it is unlikely that the area where the object supposed to be monitored is more likely to be captured is removed together with the spotted areas 401. Therefore, in a situation where the captured image such as the image 400 shown in FIG. 4 is obtained, even if the restored image is used to monitor the situation of the periphery of the vehicle 1, inconvenience is unlikely to occur.

On the other hand, in the example shown in FIG. 5, overlap between the spotted areas 501 and the road surface area 502 is large. More specifically, in the example shown in FIG. 5, an area near the center of gravity (center) of the road surface area 502, which is an example of an area where the object supposed to be monitored is more likely to be reflected, and the spotted areas 501 largely overlap. Therefore, when the image 500 shown in FIG. 5 is restored, it is more likely that the area where the object supposed to be monitored is more likely to be captured is removed together with the spotted areas 501. Therefore, in a situation where the captured image such as the image 500 shown in FIG. 5 is obtained, when the restored image is used to monitor the situation on the periphery of the vehicle 1, inconvenience is likely to occur.

From the above, it is not appropriate to always use the restored image in any situation to monitor the situation on the periphery of the vehicle 1. In particular, when the restored image is used in an inappropriate situation during execution of the substitution control, accuracy of the substitution control may decrease as a result of the object not being appropriately detected from the restored image.

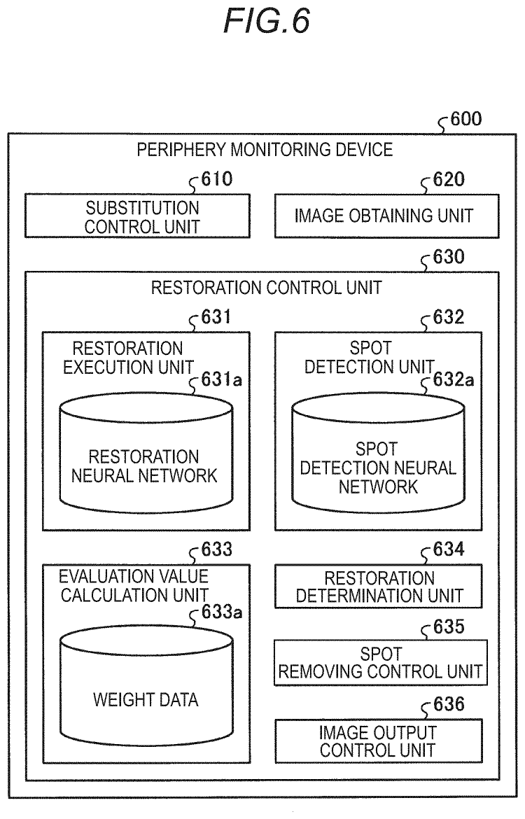

Therefore, in the embodiment, by implementing a periphery monitoring device 600 having a configuration shown in FIG. 6 in the control device 310, the restored image can be used (only) in an appropriate situation.

FIG. 6 is an exemplary and schematic block diagram showing the configuration of the periphery monitoring device 600 according to the embodiment. The configuration shown in FIG. 6 is implemented in the control device 310 by cooperation of software and hardware. That is, the configuration shown in FIG. 6 is implemented as a result of the CPU 310a of the control device 310 reading and executing a predetermined control program (periphery monitoring program) stored in the ROM 310b or the like. In the embodiment, at least a part of functions shown in FIG. 6 may be implemented by dedicated hardware (circuit).

As shown in FIG. 6, the periphery monitoring device 600 according to the embodiment includes a substitution control unit 610, an image obtaining unit 620, and a restoration control unit 630.

The substitution control unit 610 executes the substitution control by controlling at least one of the braking system 301, the acceleration system 302, the steering system 303, and the transmission system 304 described above. In an example shown in FIG. 6, the substitution control unit 610 is implemented in the periphery monitoring device 600, but in the embodiment, a function corresponding to the substitution control unit 610 may be implemented separately from the periphery monitoring device 600.

The image obtaining unit 620 obtains the captured image captured by the vehicle-mounted camera 15.

The restoration control unit 630 has a function of controlling whether to execute restoration processing of outputting a restored image restored from the captured image when the captured image includes a spotted area caused by a spot on an optical system of the vehicle-mounted camera 15, so as to simulatively reproduce a state where the optical system of the vehicle-mounted camera 15 does not have the spot by removing the spotted area according to a positional relationship between a road surface area where the road surface is captured and the spotted area in the captured image.

More specifically, the restoration control unit 630, as a configuration for implementing the function described above, includes a restoration execution unit 631, a spot detection unit 632, an evaluation value calculation unit 633, a restoration determination unit 634, a spot removing control unit 635, and an image output control unit 636.

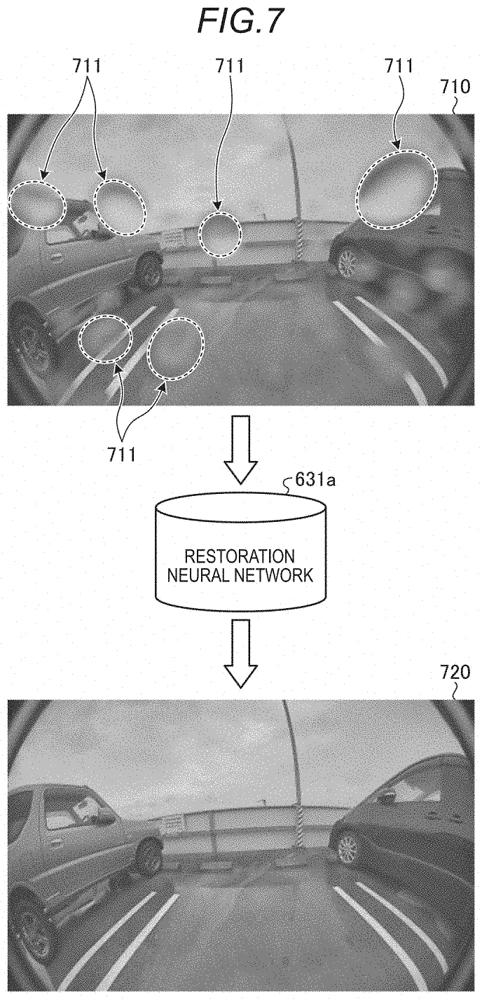

The restoration execution unit 631 generates the restored image from the captured image. More specifically, as shown in FIG. 7, the restoration execution unit 631 generates the restored image from the captured image by using a restoration neural network 631a pre-trained by machine learning so as to output the restored image according to input of the captured image.

FIG. 7 is an exemplary and schematic diagram for illustrating restoration of the captured image executed in the embodiment. In an example shown in FIG. 7, the restoration execution unit 631 obtains, by inputting a captured image 710 including spotted areas 711 caused by water droplets into the restoration neural network 631a, a restored image 720 as the captured image 710 from which the spotted areas 711 are removed.

The restoration neural network 631a as described above can be obtained by any method using the machine learning. For example, the restoration neural network 631a as described above can be obtained by causing a deep neural network to learn, by using any machine learning algorithm, a correspondence relationship between a feature amount of a first sample image corresponding to the captured image that does not include any spotted area and a feature amount of a second sample image where a spotted area is artificially added to the first sample image.

Returning to FIG. 6, the spot detection unit 632 determines whether the captured image includes a spotted area by detecting a possibility of each area (the size may be one pixel or a plurality of pixels) in the captured image corresponding to a spotted area. Details will be described later, and in the embodiment, the spot detection unit 632 detects whether the captured image includes a spotted area, and more specifically, detects spot data related to a position and a size (area) of the spotted area included in the captured image by using a spot detection neural network 632a pre-trained by the machine learning so as to output a numerical value of, for example, 0 to 1 indicating the possibility of each area in the captured image according to the input of the captured image corresponding to the spotted area.

Here, when it is determined that the captured image does not include a spotted area, there is no room to execute the restoration of the captured image. On the other hand, when it is determined that the captured image includes a spotted area, there is room to execute the restoration of the captured image. However, as described above, even if it is determined that the captured image includes a spotted area, it may be inappropriate to execute the restoration of the captured image according to the positional relationship between the road surface area where the road surface is captured and the spotted area in the captured image.

In particular, as described above, when the spotted area overlaps with the area near the center of gravity (center) of the road surface area, which is an example of the area where the object supposed to be monitored is more likely to be reflected, it is inappropriate to execute the restoration of the captured image. Therefore, in the embodiment, with a configuration described below, the restoration control unit 630 determines whether to execute the restoration of the captured image in consideration of the positional relationship between the road surface area and the spotted area, and prevents the execution of the restoration processing as the spotted area is closer to the center of gravity of the road surface area in the captured image.

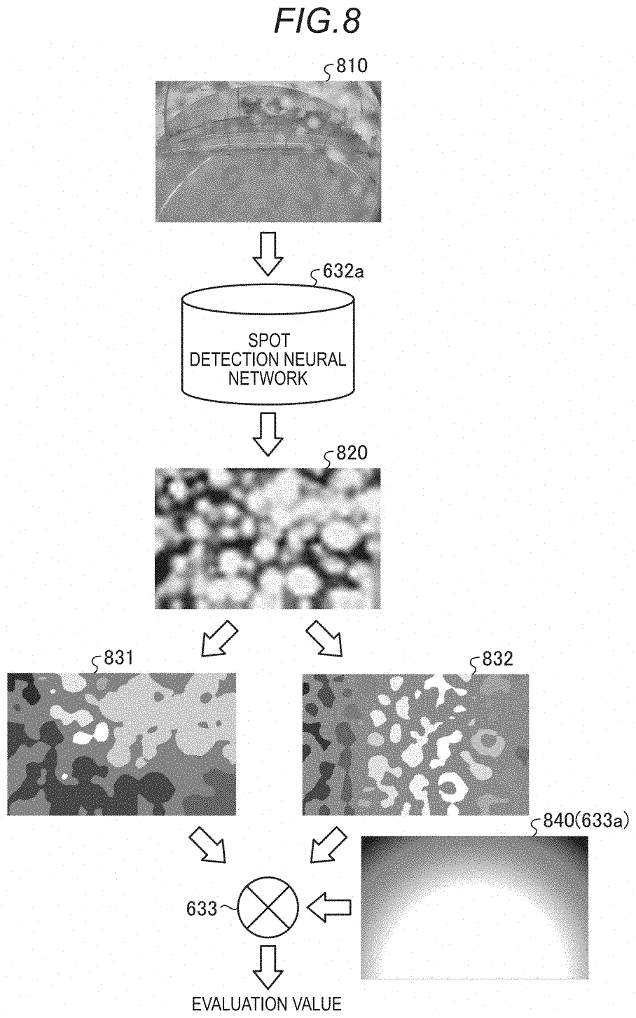

More specifically, in the embodiment, the evaluation value calculation unit 633 calculates an evaluation value that serves as a basis for determining whether to execute the restoration of the captured image by using weight data 633a related to a predetermined weight for each area in the captured image so as to have a value that varies according to a distance between the area and the center of gravity of the road surface area. The calculation of the evaluation value is executed based on the spot data detected by the spot detection unit 632 and the weight data 633a in a form shown in FIG. 8 below.

FIG. 8 is an exemplary and schematic diagram for illustrating the calculation of the evaluation value executed in the embodiment.

As shown in FIG. 8, in the embodiment, in calculating the evaluation value, first, the spot detection unit 632 inputs a captured image 810 to the spot detection neural network 632a, so as to obtain a spot detection image 820 having, as a pixel value, a numerical value of, for example, 0 to 1 indicating a possibility of each area in the captured image 810 corresponding to a spotted area. In an example shown in FIG. 8, as an example, an area with a higher possibility of corresponding to a spotted area is displayed brighter in the spot detection image 820.

Then, the spot detection unit 632 obtains, by performing threshold processing and contour tracking processing on the spot detection image 820, a processed image for obtaining the spot data related to the position and the size (area) of the spotted area.

For example, in the example shown in FIG. 8, the spot detection unit 632 obtains two processed images including a first processed image 831 and a second processed image 832, as the processed images. The first processed image 831 is a processed image obtained by performing the contour tracking processing after performing the threshold processing using a fixed threshold on each area in the spot detection image 820, and the second processed image 832 is a processed image obtained by performing the contour tracking processing after performing the threshold processing using a dynamic threshold determined in consideration of information of a periphery area on each area in the spot detection image 820.

According to the threshold processing and contour tracking processing, in each of the first processed image 831 and the second processed image 832, it is possible to obtain, for each contour, an area having a possibility of corresponding to the spotted area equal to or more than a threshold. The area thus obtained can be regarded as a target spotted area whose spot data related to the position and the size (area) is obtained. Therefore, in the embodiment, the spot detection unit 632 obtains spot data from each of the first processed image 831 and the second processed image 832 based on the area obtained based on the threshold processing and the contour tracking processing.

In the example shown in FIG. 8, the first processed image 831 and the second processed image 832 are color-coded for each area obtained based on the threshold processing and the contour tracking processing, but this is only for easy understanding. In the embodiment, it is not always necessary to color-code each area of the first processed image 831 and the second processed image 832.

Further, in the example shown in FIG. 8, the spot data is obtained from both of the two processed images, but in the embodiment, if at least one piece of the spot data can be obtained, it is not always necessary to obtain the spot data from both of the two types of processed images. For example, in the embodiment, a configuration may be adopted in which spot data is obtained from only one of the two processed images, or a configuration may be adopted in which one piece of spot data is obtained by performing calculation processing such as averaging on the spot data obtained from both of the two processed images.

The evaluation value calculation unit 633 calculates, based on the spot data obtained from (at least one of) the first processed image 831 and the second processed image 832 and the weight data 633a, the evaluation value that serves as the basis for determining whether to execute the restoration of the captured image. As shown in FIG. 8, the weight data 633a is configured, for example, as a weight image 840 having a predetermined pixel value for each area.

Here, the above-described content is repeated, but when the spotted area overlaps with the area near the center of gravity (center) of the road surface area, which is an example of the area where the object supposed to be monitored is more likely to be reflected, it is particularly inappropriate to execute the restoration of the captured image. Therefore, in the example shown in FIG. 8, the weight image 840 has a pixel value that continuously varies according to a distance from a central lower area corresponding to the area near the center of gravity of the road surface area in order to consider a degree of proximity between the spotted area and the center of gravity of the road surface area during the calculation of the evaluation value that serves as the basis for determining whether to execute the restoration of the captured image.

In the embodiment, the variation of the pixel value of the weight image 840 is not necessarily continuous. For example, the pixel value of the weight image 840 continuously changes in an area where the distance from the central lower area corresponding to the area near the center of gravity of the road surface area is equal to or less than a predetermined value, and can be set to be constant in an area where the distance from the central lower area corresponding to the area near the center of gravity of the road surface area is larger than the predetermined value.

Thus, the evaluation value calculation unit 633 according to the embodiment calculates an evaluation value that has a different value depending on whether it is appropriate or not to execute the restoration of the restored image in consideration of the positional relationship between the road surface area and the spotted area, more specifically, the degree of proximity between the center of gravity of the road surface area and the spotted area.

In the example shown in FIG. 8, the evaluation value calculation unit 633 is shown as a simple multiplier, but in the embodiment, the evaluation value calculation unit 633 is not limited to a simple multiplier. That is, in the embodiment, the evaluation value calculation unit 633 may be implemented as any combination of a plurality of calculators including a multiplier.

Returning to FIG. 6, the restoration determination unit 634 determines, based on the evaluation value calculated by the evaluation value calculation unit 633, whether to execute the restoration of the captured image. More specifically, the restoration determination unit 634 determines, based on a comparison result between the evaluation value and a predetermined threshold, whether to execute the restoration of the captured image.

In particular, as described above, when the substitution control is executed by the substitution control unit 610, it is required to use the restored image in an appropriate situation. Therefore, in the embodiment, the restoration determination unit 634 determines whether to execute the restoration of the captured image during the execution of the substitution control. Then, in the embodiment, when the restoration determination unit 634 determines that the restoration of the captured image is to be executed, the restoration execution unit 631 executes the restoration of the captured image and the substitution control unit 610 continues the substitution control. When the restoration determination unit 634 determines that the restoration of the captured image is not to be executed, the substitution control unit 610 completes the substitution control without executing the restoration of the captured image by the restoration execution unit 631.

By the way, (at least a part of) the spot on the optical system of the vehicle-mounted camera 15 may be physically removed by the spot removing unit 307. Therefore, if the above calculation of the evaluation value is executed after trying to physically remove the spot on the optical system of the vehicle-mounted camera 15, a spotted area to be detected is reduced and a load of the calculation tends to be reduced.

Therefore, in the embodiment, when the spot detection unit 632 determines that the optical system of the vehicle-mounted camera 15 has a spot, the spot removing control unit 635 tries to physically remove the spot on the optical system of the vehicle-mounted camera 15 by operating the spot removing unit 307. Thereafter, the evaluation value calculation unit 633 calculates an evaluation value based on a new captured image obtained by the image obtaining unit 620, and the restoration determination unit 634 determines whether to execute the restoration of the captured image based on the evaluation value.

The image output control unit 636 controls contents output to the display unit 8. More specifically, when the spot detection unit 632 determines that the captured image does not include a spotted area, the image output control unit 636 outputs the captured image as it is to the display unit 8. Further, when the spot detection unit 632 determines that the captured image includes a spotted area, and the restoration determination unit 634 determines that the restoration of the captured image is to be executed, the image output control unit 636 outputs a restored image generated by the restoration execution unit 631 to the display unit 8. When the restoration determination unit 634 determines that the restoration of the captured image is not to be executed, the image output control unit 636 outputs, for example, a notification that the substitution control is completed by the substitution control unit 610 to the display unit 8 (and/or the audio output unit 9), and prompts the driver of the vehicle 1 to drive manually.

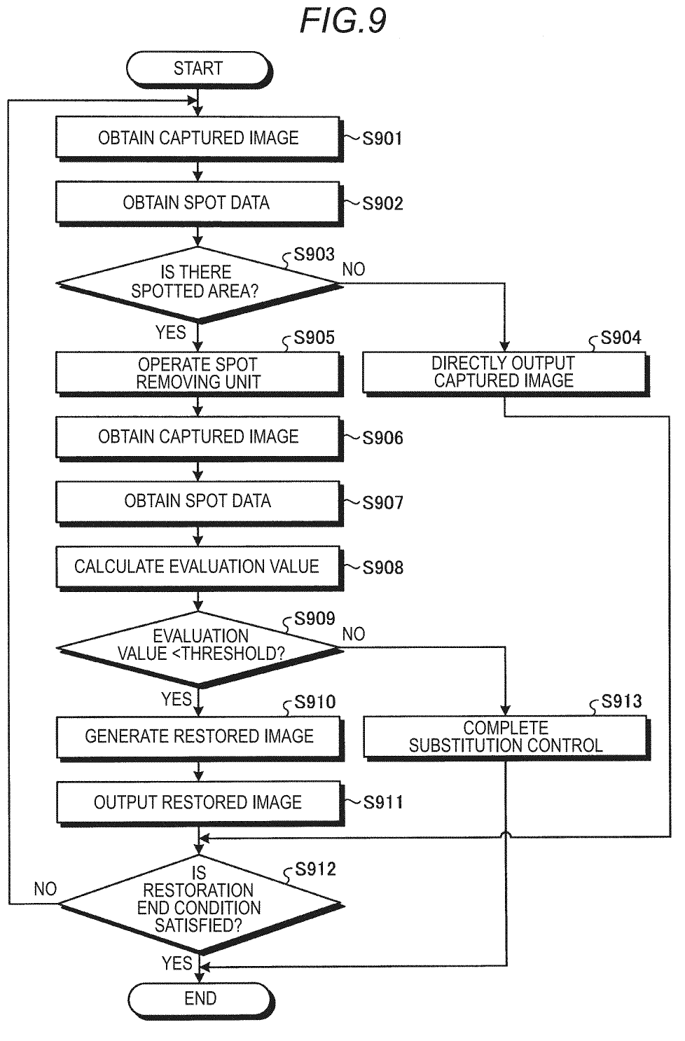

Based on the above configuration, when a restoration start condition, as a condition for starting monitoring of the situation on the periphery of the vehicle 1 using the restored image during the execution of the substitution control by the substitution control unit 610, is satisfied, the periphery monitoring device 600 according to the embodiment executes processing along a flow as shown in the following FIG. 9. The restoration start condition is, for example, a condition under which the driver of the vehicle 1 executes a predetermined operation for requesting the restoration of the captured image.

FIG. 9 is an exemplary and schematic flow chart showing a series of processing executed by the periphery monitoring device 600 according to the embodiment. The series of processing shown in FIG. 9 starts when the restoration start condition, as a condition for starting the restoration of the captured image during the execution of the substitution control based on the substitution control unit 610, is satisfied.

As shown in FIG. 9, in the embodiment, first, in S901, the image obtaining unit 620 of the periphery monitoring device 600 obtains a captured image captured by the vehicle-mounted camera 15.

Then, in S902, the spot detection unit 632 of the periphery monitoring device 600 obtains, based on the captured image obtained in S901, spot data related to a position and a size (area) of a spotted area by a procedure described with reference to FIG. 8.

Then, in S903, the spot detection unit 632 of the periphery monitoring device 600 determines whether the captured image has a spotted area based on the spot data obtained in S902.

When it is determined in S903 that the captured image does not have a spotted area, the processing proceeds to S904. Then, in S904, the image output control unit 636 of the periphery monitoring device 600 outputs the captured image as it is to the display unit 8. Then, the processing proceeds to S912 described below.

On the other hand, when it is determined in S903 that the captured image has a spotted area, the processing proceeds to S905. Then, in S905, the spot removing control unit 635 of the periphery monitoring device 600 tries to physically remove the spot on the optical system of the vehicle-mounted camera 15 by operating the spot removing unit 307.

Then, in S906, the image obtaining unit 620 of the periphery monitoring device 600 obtains the captured image captured by the vehicle-mounted camera 15 again.

Then, in S907, the spot detection unit 632 of the periphery monitoring device 600 obtains the spot data again based on the captured image obtained in S906.

Then, in S908, the evaluation value calculation unit 633 of the periphery monitoring device 600 calculates, based on the spot data obtained in S907 and the predetermined weight data 633a, an evaluation value that serves as a basis for determining whether to execute restoration processing.

Then, in S909, the restoration determination unit 634 determines whether the evaluation value calculated in S908 is smaller than a threshold. Here, as an example, an example will be described in which it is determined that the restoration processing is to be executed when the evaluation value is smaller than the threshold, and the restoration processing is not executed when the evaluation value is equal to or more than the threshold.

When it is determined in S909 that the evaluation value is smaller than the threshold, the processing proceeds to S910. Then, in S910, the restoration execution unit 631 of the periphery monitoring device 600 generates a restored image based on the captured image obtained in S906.

Then, in S911, the image output control unit 636 of the periphery monitoring device 600 outputs the restored image generated in S909 to the display unit 8.

Then, in S912, the periphery monitoring device 600 (for example, any configuration included in the restoration control unit 630) determines whether a restoration end condition, as a condition for completing monitoring of the situation on the periphery of the vehicle 1 using the restored image, is satisfied. The restoration end condition is, for example, a condition under which the driver of the vehicle 1 executes a predetermined operation for requesting completion of the restoration of the captured image.

When it is determined in S912 that the restoration end condition is not satisfied, it is necessary to continue to monitor the situation on the periphery of the vehicle 1 using the restored image. Therefore, in this case, the processing returns to S901.

On the other hand, when it is determined in S912 that the restoration end condition is satisfied, it is necessary to complete the monitoring of the situation on the periphery of the vehicle 1 using the restored image. Therefore, in this case, the processing ends.

When it is determined in S909 that the evaluation value is equal to or more than the threshold, the processing proceeds to S913. In this case, it is not appropriate to continue monitoring the situation on the periphery of the vehicle 1 using the restored image, and it is necessary to switch an automatic/semi-automatic operation of the vehicle 1 by the substitution control to a manual operation of the vehicle 1 by the driver. Therefore, in S913, the substitution control unit 610 of the periphery monitoring device 600 completes the substitution control. At this time, the image output control unit 636 can output a notification that the substitution control has completed to the display unit 8 (and/or the audio output unit 9), and prompt the driver of the vehicle 1 to drive manually. Then, the processing ends.

As described above, the periphery monitoring device 600 according to the embodiment includes the image obtaining unit 620 and the restoration control unit 630. The image obtaining unit 620 obtains a captured image captured by the vehicle-mounted camera 15 provided in the vehicle 1 so as to image an area including a road surface on periphery of the vehicle 1. The restoration control unit 630 controls, when the captured image includes a spotted area caused by the spot on the optical system of the vehicle-mounted camera 15, whether to execute restoration processing of outputting a restored image restored from the captured image so as to simulatively reproduce a state where the optical system of the vehicle-mounted camera 15 does not have the spot by removing the spotted area according to a positional relationship between a road surface area where the road surface is captured and the spotted area in the captured image.

According to the periphery monitoring device 600 according to the embodiment, by controlling whether to execute the restoration processing in consideration of the positional relationship between the road surface area and the spotted area, it is possible to prevent occurrence of a situation in which an area where an object is supposed to be captured is removed together with the spotted area in the restored image, and to use the restored image (only) in an appropriate situation.

Here, in the embodiment, the restoration control unit 630 prevents the execution of the restoration processing as the spotted area is closer to a center of gravity of the road surface area in the captured image. According to such a configuration, as the center of gravity of the road surface area where the object supposed to be monitored is more likely to be reflected and the spotted area are farther apart, the execution of the restoration processing is prevented, and thus it is possible to further prevent the occurrence of the situation in which the area where the object is supposed to be captured is removed together with the spotted area in the restored image.

Further, in the embodiment, the restoration control unit 630 switches whether to execute the restoration processing according to a comparison result between a threshold and an evaluation value, which is calculated according to a degree of proximity between the road surface area and a center of gravity of the spotted area in the captured image. According to such a configuration, it is possible to easily switch whether to execute the restoration processing only by comparing the evaluation value with the threshold.

Further, in the embodiment, when the restoration processing is not executed, the restoration control unit 630 compares the threshold with the evaluation value, which is calculated based on a newly captured image obtained by the image obtaining unit 620, after operating the spot removing unit 307 provided in the vehicle 1 to try to physically remove the spot on the optical system of the vehicle-mounted camera 15. According to such a configuration, the evaluation value can be calculated after removal of the spot that can be physically removed is tried.

Further, in the embodiment, the restoration control unit 630 calculates the evaluation value based on spot data related to a position and a size of the spotted area included in the captured image and weight data related to a predetermined weight for each area in the captured image so as to have a value that varies according to a distance between the area and the center of gravity of the road surface area. According to such a configuration, an appropriate evaluation value can be easily calculated based on the spot data and the weight data.

Further, in the embodiment, the restoration control unit 630 obtains the spot data by using the spot detection neural network 632a pre-trained by machine learning so as to output a possibility of each area in the captured image according to input of the captured image corresponding to the spotted area. According to such a configuration, the spot data can be easily obtained only by inputting the captured image to the spot detection neural network 632a.

Further, in the embodiment, the restoration control unit 630 executes the restoration processing by using the restoration neural network 631a pre-trained by the machine learning so as to output the restored image corresponding to the captured image according to the input of the captured image. According to such a configuration, the restoration processing can be easily executed only by inputting the captured image to the restoration neural network 631a.

Further, in the embodiment, the restoration control unit 630 controls whether to execute the restoration processing when substitution control for substituting at least a part of driving operation of a driver on the vehicle 1 is executed. According to such a configuration, decrease in accuracy of the substitution control can be prevented. More specifically, when the restored image is used in an inappropriate situation during the execution of the substitution control, the accuracy of the substitution control may decrease as a result of the object not being appropriately detected from the restored image. In this regard, the decrease in the accuracy of the substitution control can be prevented by appropriately controlling whether to execute the restoration processing during the execution of the substitution control.

The periphery monitoring program executed in the control device 310 according to the embodiment may be provided in a state of being pre-installed in a storage device such as the ROM 310b or the SSD 310d, or may be provided as a computer program product recorded in a computer-readable recording medium, such as various magnetic disks such as a flexible disk (FD) or various optical disks such as a digital versatile disk (DVD), in an installable form or an executable form.

Further, the periphery monitoring program executed in the control device 310 according to the embodiment may be provided or distributed via a network such as Internet. That is, the periphery monitoring program executed in the control device 310 according to the embodiment may be provided in a form of to be downloaded from a computer via the network in a state of being stored in the computer connected to the network such as Internet.

### <Modification>

In the embodiment described above, a configuration is mainly shown on an assumption that the center of gravity of the road surface area exists in the central lower area of the captured image. In the configuration, weight data is always fixedly set based on the central lower area of the captured image, and a restoration control unit controls whether to execute restoration processing according to a positional relationship between the central lower area of the captured image and a spotted area on the premise that the center of gravity of the road surface area is in the central lower area of the captured image. However, in the embodiment, the restoration control unit has a function as a road surface estimation unit that estimates the road surface area from the captured image by image processing or the like, and may also be configured to control whether to execute the restoration processing according to the positional relationship between the road surface area estimated by the road surface estimation unit and the spotted area. In the configuration, the weight data is dynamically set on based on the center of gravity of the road surface area that can vary according to an estimation result of the road surface estimation unit.

Further, in the embodiment described above, a configuration is shown in which a result of machine learning executed in advance is used to execute the restoration of the captured image and the calculation of the spot data. However, the restoration of the captured image and the calculation of the spot data may be executed based on a rule. That is, the restoration of the captured image and the calculation of the spot data may be executed based on a certain rule artificially determined based on a large number of pieces of data.

Further, in the embodiment described above, a configuration is shown in which the evaluation value is calculated by executing predetermined calculation based on predetermined weight data and the spot data which is calculated by using the result of the machine learning executed in advance. However, the calculation of the evaluation value may be executed by using a neural network pre-trained by the machine learning so as to output an evaluation value corresponding to the captured image according to the input of the captured image.

A periphery monitoring device according to an aspect of this disclosure includes: an image obtaining unit configured to obtain a captured image captured by an image capturing unit provided in a vehicle so as to image an area including a road surface on periphery of the vehicle; and a restoration control unit configured to control, when the captured image includes a spotted area caused by a spot on an optical system of the image capturing unit, whether to execute restoration processing of outputting a restored image restored from the captured image so as to simulatively reproduce a state where the optical system of the image capturing unit does not have the spot by removing the spotted area, according to a positional relationship between a road surface area where the road surface is captured and the spotted area in the captured image.

According to the periphery monitoring device described above, by controlling whether to execute the restoration processing in consideration of the positional relationship between the road surface area and the spotted area, it is possible to prevent occurrence of a situation in which an area where an object is supposed to be captured is removed together with the spotted area from the restored image. Accordingly, the restored image can be used in an appropriate situation.

In the periphery monitoring device described above, the restoration control unit may be configured to prevent the execution of the restoration processing as the spotted area is closer to a center of gravity of the road surface area in the captured image. According to such a configuration, as the center of gravity of the road surface area where the object supposed to be monitored is more likely to be reflected and the spotted area are farther apart, the execution of the restoration processing is prevented, and thus it is possible to further prevent the occurrence of the situation in which the area where the object is supposed to be captured is removed together with the spotted area from the restored image.

In this case, the restoration control unit may be configured to switch whether to execute the restoration processing according to a comparison result between a threshold and an evaluation value which is calculated according to a degree of proximity between the road surface area and a center of gravity of the spotted area in the captured image. According to such a configuration, it is possible to easily switch whether to execute the restoration processing only by comparing the evaluation value with the threshold.

In the above configuration using the evaluation value, the restoration control unit may be configured to compare, when the restoration processing is not executed, the threshold with the evaluation value which is calculated based on a new captured image obtained by the image obtaining unit, after a spot removing unit provided in the vehicle is operated to try to physically remove the spot on the optical system of the image capturing unit. According to such a configuration, the evaluation value can be calculated after removal of the spot that can be physically removed is tried.

Further, in the above configuration using the evaluation value, the restoration control unit may be configured to calculate the evaluation value based on spot data related to a position and a size of the spotted area included in the captured image, and weight data related to a weight predetermined for each area in the captured image such that a value of the weight varies according to a distance between each area and the center of gravity of the road surface area. According to such a configuration, an appropriate evaluation value can be easily calculated based on the spot data and the weight data.

In this case, the restoration control unit may obtain the spot data using a spot detection neural network pre-trained by machine learning so as to output a possibility of corresponding to the spotted area of each area in the captured image according to input of the captured image. According to such a configuration, the spot data can be easily obtained only by inputting the captured image to the spot detection neural network.

In the periphery monitoring device described above, the restoration control unit may be configured to execute the restoration processing using a restoration neural network pre-trained by machine learning so as to output the restored image corresponding to the captured image according to the input of the captured image. According to such a configuration, the restoration processing can be easily executed only by inputting the captured image to the restoration neural network.

Further, in the periphery monitoring device described above, the restoration control unit may be configured to control whether to execute the restoration processing when substitution control for substituting at least a part of driving operation of a driver on the vehicle is executed. According to such a configuration, decrease in accuracy of the substitution control can be prevented. More specifically, when the restored image is used in an inappropriate situation during the execution of the substitution control, the accuracy of the substitution control may decrease as a result of the object not being appropriately detected from the restored image. In this regard, the decrease in the accuracy of the substitution control can be prevented by appropriately controlling whether to execute the restoration processing during the execution of the substitution control.

Further, in the periphery monitoring device described above, the restoration control unit may be configured to control whether to execute the restoration processing according to a positional relationship between a central lower area of the captured image and the spotted area on the premise that the center of gravity of the road surface area is in the central lower area of the captured image. According to such a configuration, on the premise that the center of gravity of the road surface area is in the central lower area of the captured image, it is possible to easily specify the positional relationship that serves as a basis of the control of whether to execute the restoration processing.

Further, the periphery monitoring device described above may further include a road surface estimation unit configured to estimate the road surface area from the captured image, and the restoration control unit may control whether to execute the restoration processing according to a positional relationship between the road surface area estimated by the road surface estimation unit and the spotted area. According to such a configuration, by using an estimation result of the road surface estimation unit, it is possible to appropriately specify the positional relationship that serves as the basis of the control of whether to execute the restoration processing.

Anon-transitory computer readable medium according to another aspect of this disclosure stores a periphery monitoring program for causing a computer to execute: an image obtaining step of obtaining a captured image captured by an image capturing unit provided in a vehicle so as to image an area including a road surface on periphery of the vehicle; and a restoration control step of controlling, when the captured image includes a spotted area caused by a spot on an optical system of the image capturing unit, whether to execute restoration processing of outputting a restored image restored from the captured image so as to simulatively reproduce a state where the optical system of the image capturing unit does not have the spot by removing the spotted area, according to a positional relationship between a road surface area where the road surface is captured and the spotted area in the captured image.

According to the periphery monitoring program described above, by controlling whether to execute the restoration processing in consideration of the positional relationship between the road surface area and the spotted area, it is possible to prevent occurrence of a situation in which an area where an object is supposed to be captured is removed together with the spotted area from the restored image. Accordingly, the restored image can be used in an appropriate situation.

While embodiments and modifications disclosed here have been described, these embodiments and modifications have been presented by way of example only, and are not intended to limit the scope of the disclosure. Indeed, these embodiments and modifications described herein may be embodied in a variety of forms; furthermore, various omissions, substitutions and changes in the form of these embodiments and modifications described herein may be made without departing from the spirit of the disclosure. The accompanying claims and their equivalents are intended to cover such forms or modifications as would fall within the scope and spirit of the disclosure.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A periphery monitoring device comprising:
an image obtaining unit configured to obtain a captured image captured by an image capturing unit provided in a vehicle so as to image an area including a road surface on periphery of the vehicle; and
a restoration control unit configured to control, when the captured image includes a spotted area caused by a spot on an optical system of the image capturing unit, whether to execute restoration processing of outputting a restored image restored from the captured image so as to simulatively reproduce a state where the optical system of the image capturing unit does not have the spot by removing the spotted area, according to a positional relationship between a road surface area where the road surface is captured and the spotted area in the captured image.

2. The periphery monitoring device according to claim 1, wherein
the restoration control unit is configured to prevent the execution of the restoration processing as the spotted area is closer to a center of gravity of the road surface area in the captured image.

3. The periphery monitoring device according to claim 2, wherein
the restoration control unit is configured to switch whether to execute the restoration processing according to a comparison result between a threshold and an evaluation value which is calculated according to a degree of proximity between the road surface area and a center of gravity of the spotted area in the captured image.

4. The periphery monitoring device according to claim 3, wherein
the restoration control unit is configured to, when the restoration processing is not executed, compare the threshold with the evaluation value which is calculated based on a new captured image obtained by the image obtaining unit, after a spot removing unit provided in the vehicle is operated to try to physically remove the spot on the optical system of the image capturing unit.

5. The periphery monitoring device according to claim 3, wherein
the restoration control unit is configured to calculate the evaluation value based on spot data related to a position and a size of the spotted area included in the captured image, and weight data related to a weight predetermined for each area in the captured image such that a value of the weight varies according to a distance between each area and the center of gravity of the road surface area.

6. The periphery monitoring device according to claim 5, wherein
the restoration control unit is configured to obtain the spot data using a spot detection neural network pre-trained by machine learning so as to output a possibility of corresponding to the spotted area of each area in the captured image according to input of the captured image.

7. The periphery monitoring device according to claim 1, wherein
the restoration control unit is configured to execute the restoration processing using a restoration neural network pre-trained by machine learning so as to output the restored image corresponding to the captured image according to the input of the captured image.

8. The periphery monitoring device according to claim 1, wherein
the restoration control unit is configured to control whether to execute the restoration processing when substitution control for substituting at least a part of driving operation of a driver on the vehicle is executed.

9. The periphery monitoring device according to claim 1, wherein
the restoration control unit is configured to control whether to execute the restoration processing according to a positional relationship between a central lower area of the captured image and the spotted area on the premise that the center of gravity of the road surface area is in the central lower area of the captured image.

10. The periphery monitoring device according to claim 1, further comprising:
a road surface estimation unit configured to estimate the road surface area from the captured image, wherein
the restoration control unit is configured to control whether to execute the restoration processing according to a positional relationship between the road surface area estimated by the road surface estimation unit and the spotted area.

11. A non-transitory computer readable medium storing a periphery monitoring program for causing a computer to execute:
an image obtaining step of obtaining a captured image captured by an image capturing unit provided in a vehicle so as to image an area including a road surface on periphery of the vehicle; and
a restoration control step of controlling, when the captured image includes a spotted area caused by a spot on an optical system of the image capturing unit, whether to execute restoration processing of outputting a restored image restored from the captured image so as to simulatively reproduce a state where the optical system of the image capturing unit does not have the spot by removing the spotted area, according to a positional relationship between a road surface area where the road surface is captured and the spotted area in the captured image.
